(19) United States
(12) Patent Application Publication
(10) Pub. No.: US 2017/0004113 A1
(43) Pub. Date: Jan. 5, 2017

(54) Seamless Font Updating

(71) Applicant: Microsoft Technology Licensing , LLC, Redmond, WA (US)

(72) Inventors: Abhijit Gore, Seattle, WA (US); Jon Esterly, Seattle, WA (US); Shashidhar Rajashekara, Seattle, WA (US)

(21) Appl. No.: 14/788,508

(22) Filed: Jun. 30, 2015

(51) Int. Cl. G06F 17/21; G06F 3/0482

(52) U.S. Cl. CPC G06F 17/214; G06F 3/0482

(57) ABSTRACT

Technologies are described herein for seamless and automatic updating of fonts in a user interface. An example method includes receiving a selection of a portion of text in a document. The portion of the text is rendered in a first font. The method further includes receiving a request to update or change the first font for the selected portion of the text, displaying a font listing of available fonts in response to the received request, and receiving a selection of a second font from the font listing. The second font is a font available from a font service. The method also includes initiating an asynchronous download of the second font from the font service, and in response to the asynchronous download of the second font being complete and successful, refreshing or re-rendering of the selected portion of the text in the second font.

### BACKGROUND

Mobile devices can offer a variety of computing resources, including an operating system for executing mobile applications. Generally, mobile applications mimic the aesthetics and function of desktop applications, while being organized to execute on a mobile device. However, mobile devices can have limited resources including total memory, processing capability, and other resources due to physical limitations of the actual mobile device. For example, a mobile device such as a smartphone can include a limited amount of memory to permit other components required for mobile communication to be integrated alongside the memory. Furthermore, some tablet computers can include limited memory in an effort to reduce component cost. Still further, other limitations on resources may be apparent based on a number of design choices or other required specifications.

In mobile devices with a limited amount of memory or processing resources, the total size of a mobile application can impact a user's decision to access, use, and/or purchase the mobile application. Other considerations such as cellular data usage, frequency of updates, and other considerations affecting utilized memory of the mobile device can also impact adoption of the mobile application across a large base of users. These concerns can be particularly true with respect to mobile applications that utilize fonts that can occupy a significant portion of the already limited memory of a mobile device.

### SUMMARY

The techniques discussed herein facilitate the seamless and automatic updating of fonts on a computing device, such as a mobile device. As described herein, various methods and systems of updating of fonts are provided. As further described herein, various methods of updating fonts allow selection of fonts, downloading of fonts, and updating of fonts on a computing device with simplified and/or limited user-interaction.

According to one example, a device includes a processor and a memory, and the memory stores an application. The application is configured to receive a selection of a portion of text in a document, and the portion of the text is rendered in a first font within a viewing port of a user interface provided by the application. The application is also configured to receive a request to update or change the first font for the selected portion of the text, display a font listing of available fonts in response to the received request, and receive a selection of a second font from the font listing. The second font is a font available from a font service in operative communication with the device. The application is further configured to initiate an asynchronous download of the second font from the font service, and, in response to the asynchronous download of the second font being complete and successful, refresh or re-render of the selected portion of the text in the second font.

According to another example, a system includes a host computer having a font service deployed thereon and configured to serve font files to client computing devices, and a client computing device having an application deployed thereon. The application is configured to receive a request to update or change a first font associated with text in a document from a user interface generated by the application, display a font listing of available fonts in response to the received request, and receive a selection of a second font from the font listing. The second font is a font available from the font service. The application is further configured to initiate an asynchronous download of the second font from the font service, and, in response to the asynchronous download of the second font being complete and successful, automatically refresh or re-render the text in the second font.

According to yet another example, a system for seamless and automatic updating of fonts across client computing devices includes a host computer having a font service executing thereupon, a font data store in operative communication with the font service and configured to store font files, and a client computing device in operative communication with the font service. The font service is configured to serve the font files to client computing devices. Additionally, the client computing device includes an application deployed thereon and configured to receive a selection of a portion of text in a document. The portion of the text is rendered in a first font in a view port of a user interface provided by the application. The application is further configured to receive a request to update or change the first font for the selected portion of the text, and display a font listing of available fonts in response to the received request. The font listing includes at least a second font and a user interface element indicating that the second font is available to download from the font service. The application is further configured to receive a selection of the second font from the font listing, initiate an asynchronous download of the second font from the font service, display an indication that the second font is being downloaded, determine a temporary font related to the second font that is available at the client computing device in response to initiating the asynchronous download, and render the selected text in the temporary font. Furthermore, the application is configured to determine that the asynchronous download of the second font is complete and successful, in response to determining that the asynchronous download of the second font is complete and successful, determine that a user interface in communication with the mobile application is idle, and in response to determining that the user interface is idle, refresh or re-render the selected text in the second font.

The above-described subject matter can also be implemented in other ways, such as a computer-controlled apparatus, a computer process, a computing system, or as an article of manufacture such as a computer-readable storage medium, for example. Although the technologies presented herein are primarily disclosed in the context of mobile applications, the technologies disclosed herein are also applicable in other forms including deployment of applications for a variety of platforms. Other variations and implementations can also be utilized. These and various other features will be apparent from a reading of the following Detailed Description and a review of the associated drawings.

This Summary is provided to introduce a selection of the technologies disclosed herein in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram showing aspects of an illustrative operating environment and several logical components provided by the technologies described herein;

FIG. 2 is a flowchart showing aspects of one illustrative routine for updating of fonts, according to one implementation presented herein;

FIG. 3 is a flowchart showing aspects of one illustrative routine for updating of fonts, according to one implementation presented herein;

FIGS. 4A-4H are diagrams of a user interface in various stages of updating fonts, according to one implementation presented herein;

FIG. 5 is a computer architecture diagram illustrating an illustrative computer hardware and software architecture for a computing system capable of implementing aspects of the configurations presented herein;

FIG. 6 is a diagram illustrating a distributed computing environment capable of implementing aspects of the configurations presented herein; and

FIG. 7 is a computer architecture diagram illustrating a computing device architecture capable of implementing aspects of the configurations presented herein.

### DETAILED DESCRIPTION

The following detailed description is directed to technologies for seamless and automatic updating of fonts in a user interface. The use of the technologies presented herein enable mobile applications to be deployed with a reduced number of initial font files, while also enabling seamless updating of font files as new fonts are requested by a user. The updating can require reduced or limited user interaction such that user experiences are improved. Furthermore, the reduced number of initial font files improves memory usage of a device storing the mobile applications and reduces bandwidth necessary to deploy the mobile applications. Additionally, updated font files can be regularly maintained based on usage analytics such that a threshold maximum memory utilization for the mobile application is maintained.

Generally, a client computing device can include an application, such as a mobile application or a document editing application, deployed thereon. During editing of a document using a user interface for the mobile application, a user of the client computing device can access a font catalog file through the user interface such that a listing of available fonts are displayed for user selection. The listing of available fonts can include designator elements identifying fonts stored at the client computing device and fonts that must be received over a data connection, such as a cellular data connection or an Internet connection.

Upon selection of a font from the listing of fonts, the mobile application accesses user settings to determine an appropriate manner by which to update or download the selected font. The user settings can include, for example, cellular data connection settings or other settings stipulating when or how a font file can be downloaded. Upon consideration of the user settings, the mobile application can generate a request to asynchronously download the requested font file from a font service.

The font service is deployed at a computing network and can maintain a font data store. The font data store can be configured to store and maintain font files for one or more mobile applications. The font service can receive requests from client computing devices for one or more font files. The font service can identify and retrieve the requested font files from the font data store. Additionally, the font service can transmit the retrieved font files to the requesting client computing devices.

Upon receipt of a requested font file, the mobile application can determine an appropriate time to re-render a document using the received font file. Upon determining the appropriate time, the mobile application can re-render the document using the received font file for viewing by a user through the user interface. Furthermore, during receipt (or during an active download of the font file), different user interface elements and/or animations can be displayed at the user interface to inform the user of a status of the requested font download. In this manner, a user can continue to edit the document in a first font while the requested font is being downloaded.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, circuits, and other types of software and/or hardware structures that perform particular tasks or implement particular data types. Moreover, those skilled in the art will appreciate that the subject matter described herein can be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration as specific implementations or examples. Referring now to the drawings, aspects of a computing system and methodology for cross-language speech recognition and translation will be described in detail.

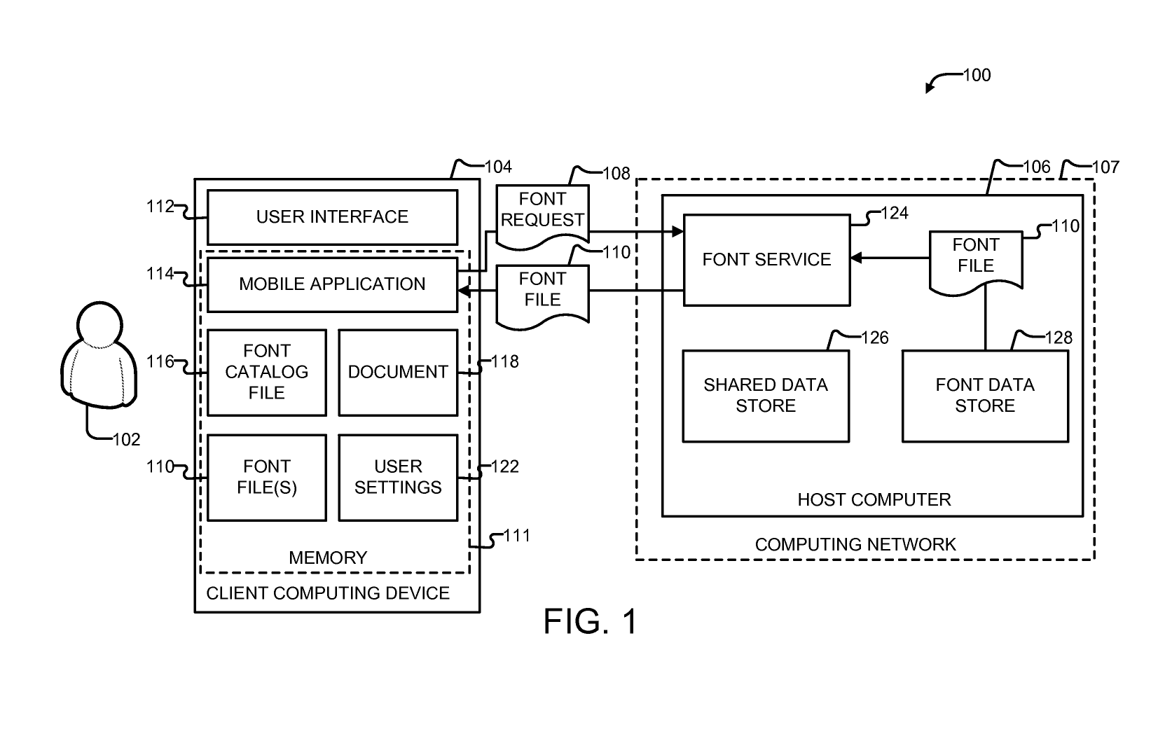

FIG. 1 illustrates an operating environment and several logical components provided by the technologies described herein. In particular, FIG. 1 is a diagram showing aspects of a system 100 for seamless and automatic updating of fonts requested by a user 102 of a client computing device 104. The client computing device 104 includes any suitable device, including but not limited to a mobile phone, a personal electronic device, a wearable computer, a smart watch, a smart phone, a smart display panel, a desktop computer, a netbook computer, a tablet computer, and/or a laptop computer. The client computing device 104 can be in communication with a host computer 106 deployed at a computing network 107. Generally, the client computing device 104 includes a memory 111 for storing data such as programs, components, and other data. The memory 111 includes a mobile application 114 stored thereon. The mobile application 114 transmits a font request 108 to the host computer 106. Additionally, in response to the font request 108, the host computer 106 can transmit the requested font file 110 to the client computing device 102.

The client computing device 102 also includes a user interface 112 deployed thereon. The user interface 112 is a graphical user interface in some implementations. The user interface 112 can be configured to display graphical elements as directed by the mobile application 114 also deployed at the client computing device. The mobile application 114 can be a relatively compact application configured to be executed by one or more processors or processing cores of a mobile device. The mobile application 114 can also be implemented as a standalone executable application capable of being executed by any suitable computer apparatus, in some implementations.

The mobile application 114 can maintain a font catalog file 116 that identifies all font files 110 available at the client computing device 102 and all font files available through requests issued to the host computer 106. Local font files 110 can include one or more font files local to the client computing device 102. The mobile application 114 can utilize one or more of the local font files 110 for rendering of a document 118 through the user interface 112. For example, the mobile application 114 can process data stored in the document 118 to extract textual information for rendering in one or more typefaces representable through the font files 110. The rendered text can be displayed to the user 102 through the user interface 112.

The memory 111 can also have user settings 122 stored thereon. The user settings 122 can represent any desired user settings, including data usage settings, data usage restrictions, maximum memory allocation for the mobile application 114, font catalog file 116, and font files 110, or other suitable settings. Additionally, according to at least one implementation, the user settings 122 include privacy settings allowing the user 102 to opt-in or opt-out of any analytics or metrics-tracking, or other such privacy settings.

As stated above, the user 102 can interact with the user interface 112 that is used to render the document 118. Furthermore, the user 102 can access user interface elements, including font listings, to select and request new or updated font files to be downloaded to the client computing device 102. The font requests 108 can be processed by the host computer 106 such that the requested font files 110 are provided to the client computing device 104. The font catalog file 116 can also be updated to indicate that a received font file 110 is now stored locally on the client computing device 104. Thus, through updating of font files 110 stored at the client computing device 104 by requesting font files from the host computer 106, utilization of the memory 111 is improved.

The host computer 106 includes a font service 124 deployed thereon configured to receive the font request 108 from the mobile application 114. The font request can include identification of one or more font files being requested by the user 102. The font service 124 can identify and retrieve the requested font file 110 from a font data store 128 deployed at the host computer 106. Thereafter, the font service 124 can transmit the font file 110 to the client computing device 104 for storage with the font files 110.

Additionally, the host computer 106 can include a shared data store 126 deployed thereon and configured to store data related to mobile application 114 and any font files 110 stored at the client computing device 104. Using the shared data store 126, the font service 124 can distribute fonts used in the document 118 to other users with access to a shared version of the document 118 such that font files for appropriate rendering of the shared version of the document 118 are distributed to the other users. The shared data store 126 can also store other information useful in collaborative editing of shared documents, including user permissions, display properties, font files, and user settings.

As described above, user 102 can request that new fonts or updated fonts be downloaded to the client computing device 104 through selection of an available font through the user interface 112. The mobile application 114 can generate the font request 108 for transmitting to the font service 124. Thereafter, the font service 124 can provide the requested font file 110 to the mobile application for storage and use at the client computing device 104. Hereinafter, additional details as to the operation and function of the user interface 112, the mobile application 114, and the font service 124 are provided with reference with FIGS. 2-4.

FIG. 2 is a flowchart showing aspects of one illustrative method 200 for updating of fonts, according to one implementation presented herein. As shown in FIG. 2, the mobile application 114 receives a text selection, or a selection of text, at block 202. Thereafter, the mobile application 114 receives an indication to change the font of the selected text, at block 204. However, if no selection of a font is received, the indication to change the font can be considered a request to change the font of newly entered text, or change the font for all text in a document, depending upon any particular implementation.

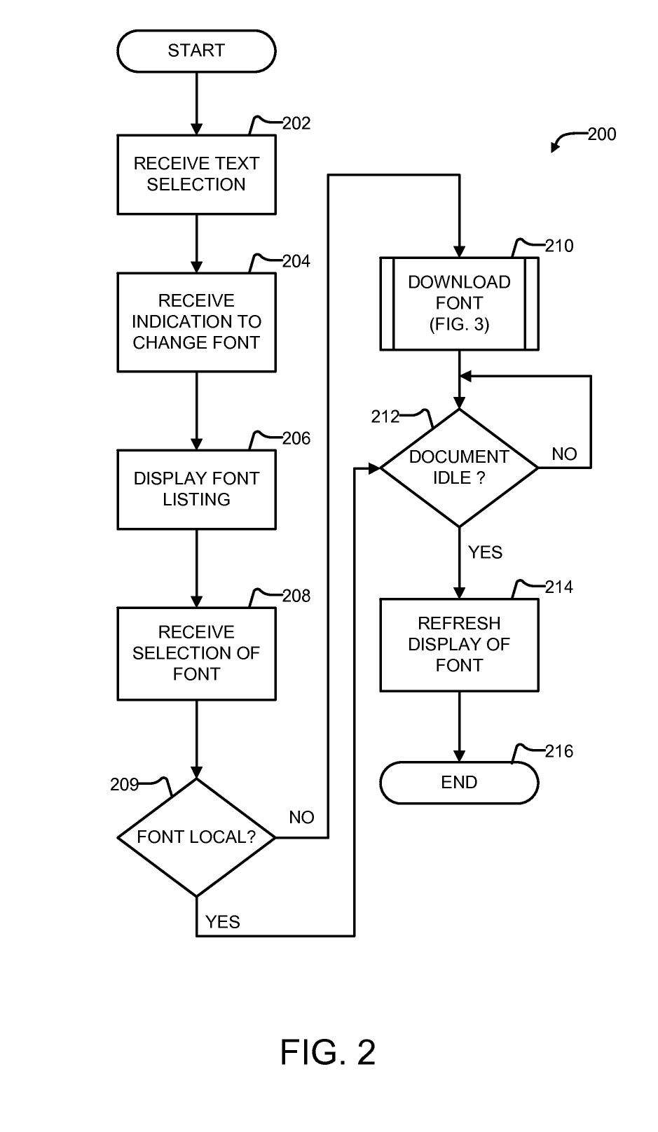

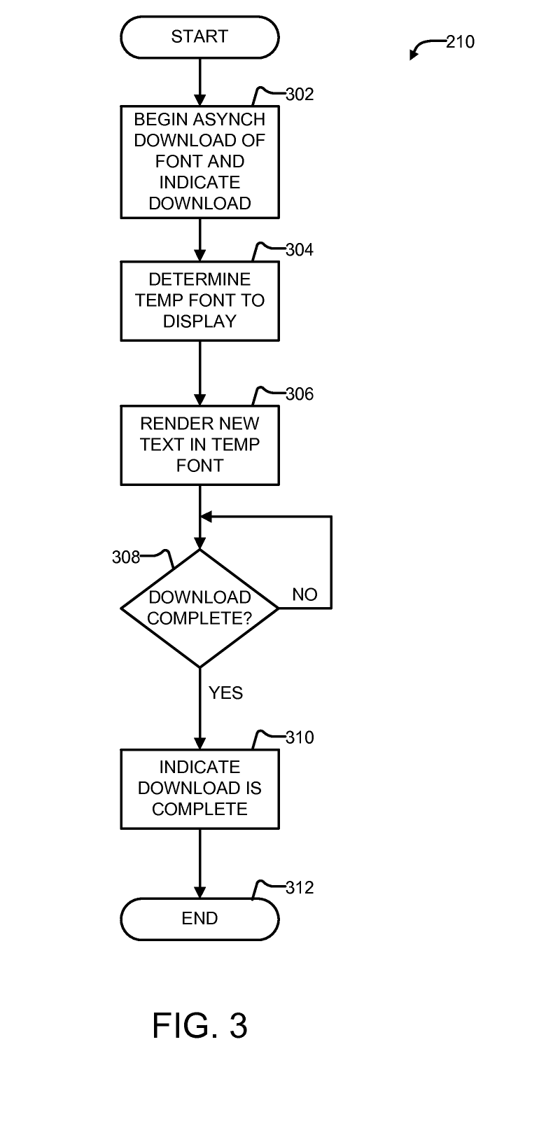

Upon receiving an indication to change the font, the mobile application 114 directs the user interface 112 to display a font listing of all available fonts, at block 206. Upon display, the user 102 can select a desired font through the user interface 112 and the mobile application 114 can receive the font selection, at block 208. If the font selection is for a non-local font as determined through block 209, the mobile application can attempt to download the font. Using the font selection to determine an appropriate font file 110 for download, the mobile application 114 can initiate an asynchronous download of the font file at block 210. Additionally, the download of a font can also be triggered by opening a document 118 that uses fonts not found on a local device, such as the client computing device 104. In such a scenario, the download is automatically triggered and document 118 refreshed as described above. Additional details regarding downloading of the font file 110 are provided below with reference to FIG. 3.

Upon downloading of the font file at block 210, or upon determining that the font selection is for a locally available font at block 209, the mobile application 114 can determine if document editing or other interactions with the user interface 112 are taking place, at block 212. The user interface 112 can be considered idle if the user 102 has not interacted with the user interface 112 for a predetermined or desired amount of time. The amount of time may be varied, and may be specified by the user 102 in the user settings 122. The user interface 112 may also be considered idle if a processing thread related to the mobile application 114 is idle. Other forms of determining whether the user interface 112 is idle may be applicable in some implementations.

Once the user interface 112 is idle, the mobile application 114 can refresh the display of the selected text in the user interface 112, or other text, in the newly downloaded font, at block 214. The refreshing or re-rendering of one or more portions of the document 118 can include updating viewed portions of text in a display port or viewed port of the user interface 112 first, and updating other non-viewed portions of the document 118 after updating of the viewed portions. For example, if a user is viewing a first page of a document in the user interface 112, the first page can be re-rendered in the new font while subsequent pages are rendered after the first page. Additionally, the re-rendering and/or refreshing is an automatic process, requiring little or no interaction by a user. The re-rendering can be varied in other ways depending upon any desired implementation or effect. After re-rendering or refreshing the document 118, the method 200 can cease at block 216.

FIG. 3 is a flowchart showing aspects of one illustrative method 210 for updating of fonts, according to one implementation presented herein. As shown in FIG. 3, the mobile application 114 can begin an asynchronous download of the requested font, and indicates an active download is in progress, at block 302. While the download is in progress, the mobile application 114 can determine a temporary font in which to display text, at block 304. The determining of the temporary text can include, for example, utilizing a PANOSE methodology for identifying a font that adequately matches any of several attributes of the requested font. A PANOSE methodology includes methods for identifying fonts based solely on visual characteristics. PANOSE methodologies can be used match a known font to a close visual neighbor from a number of available fonts, such as font files 110 or fonts available through the font data store 128.

Upon determining a temporary font, the mobile application 114 can render the text in the temporary font, at block 306. In some implementations, blocks 304 and 306 are optional and may be omitted. According to other implementations, the text can be updated in the temporary font only if the user interface 112 is idle, as described above with regard to re-rendering a document.

Subsequently, the mobile application 114 can determine if the asynchronous download of the font file 110 is complete at block 308. Upon determining the download is complete, the mobile application 114 can indicate the font download is complete at block 310, and the method 210 can cease at block 312.

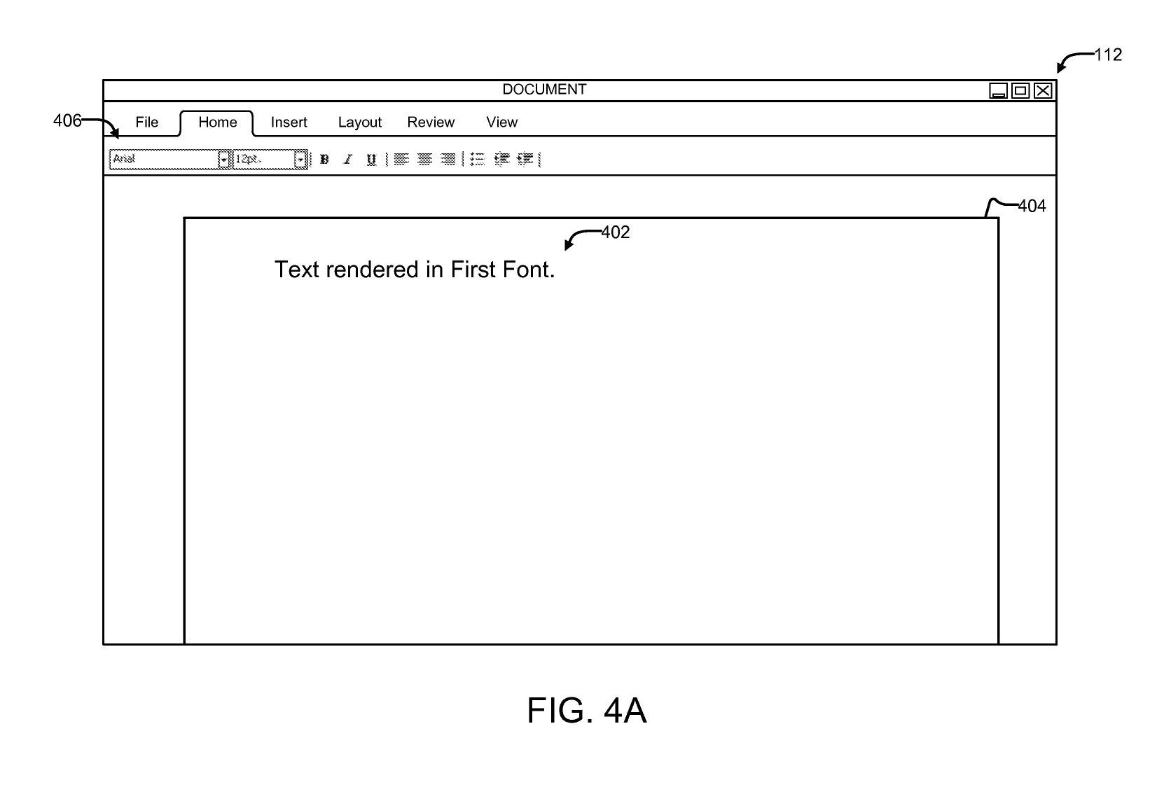

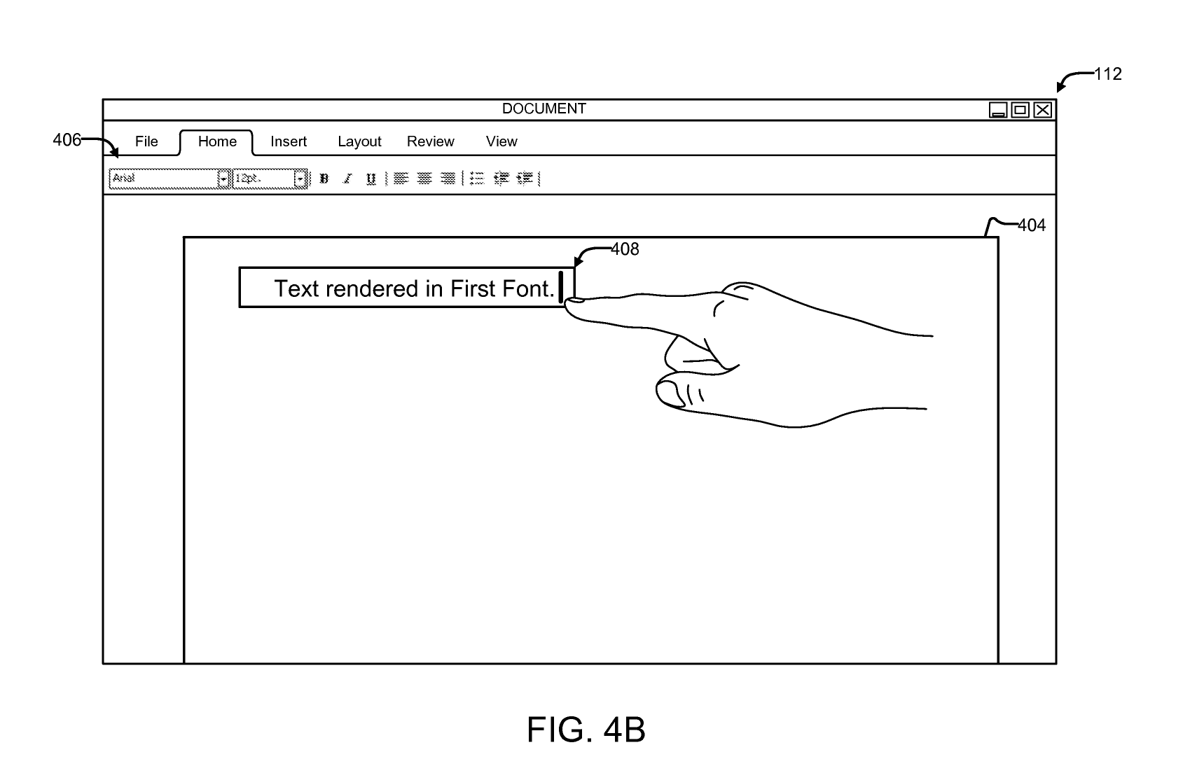

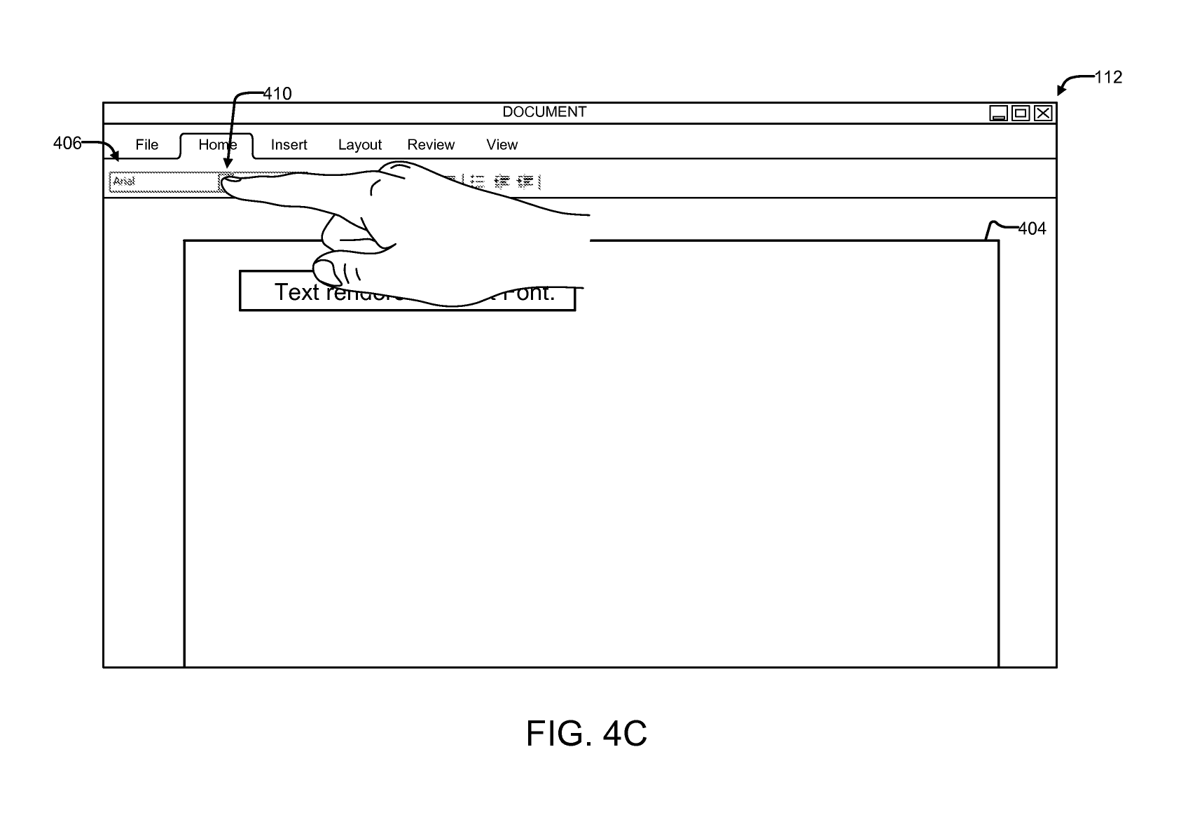

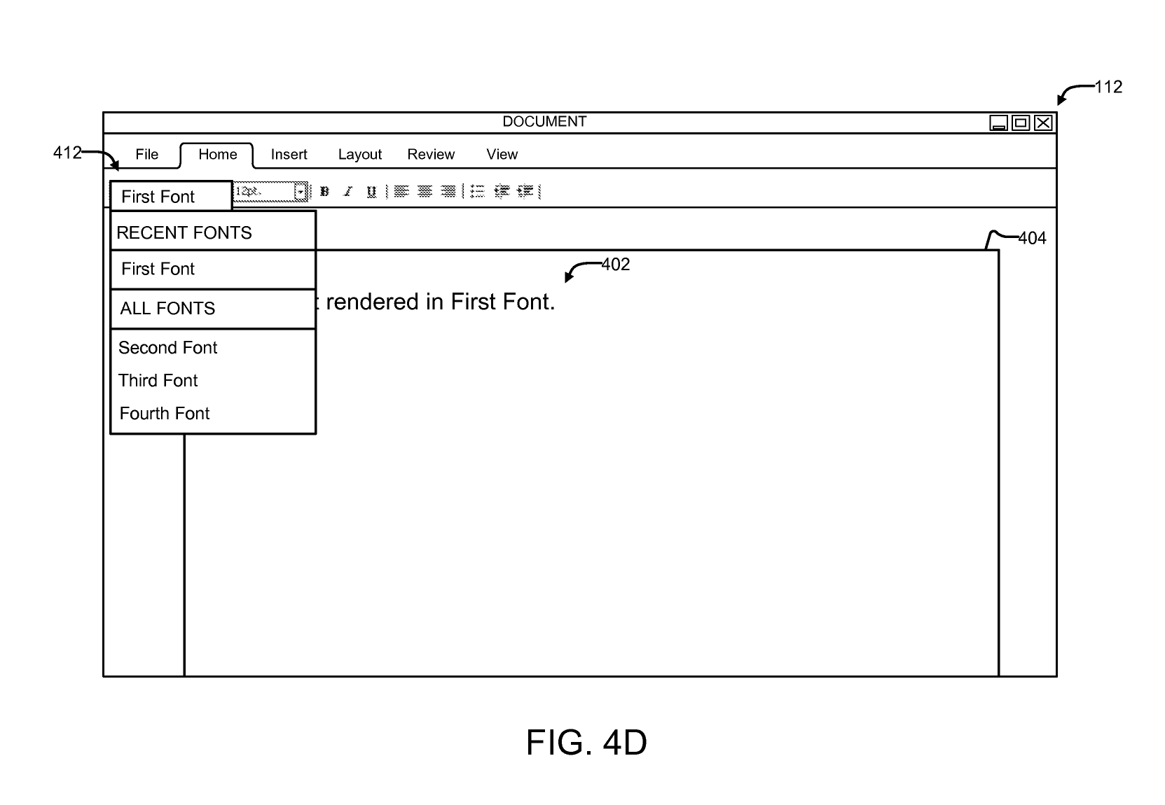

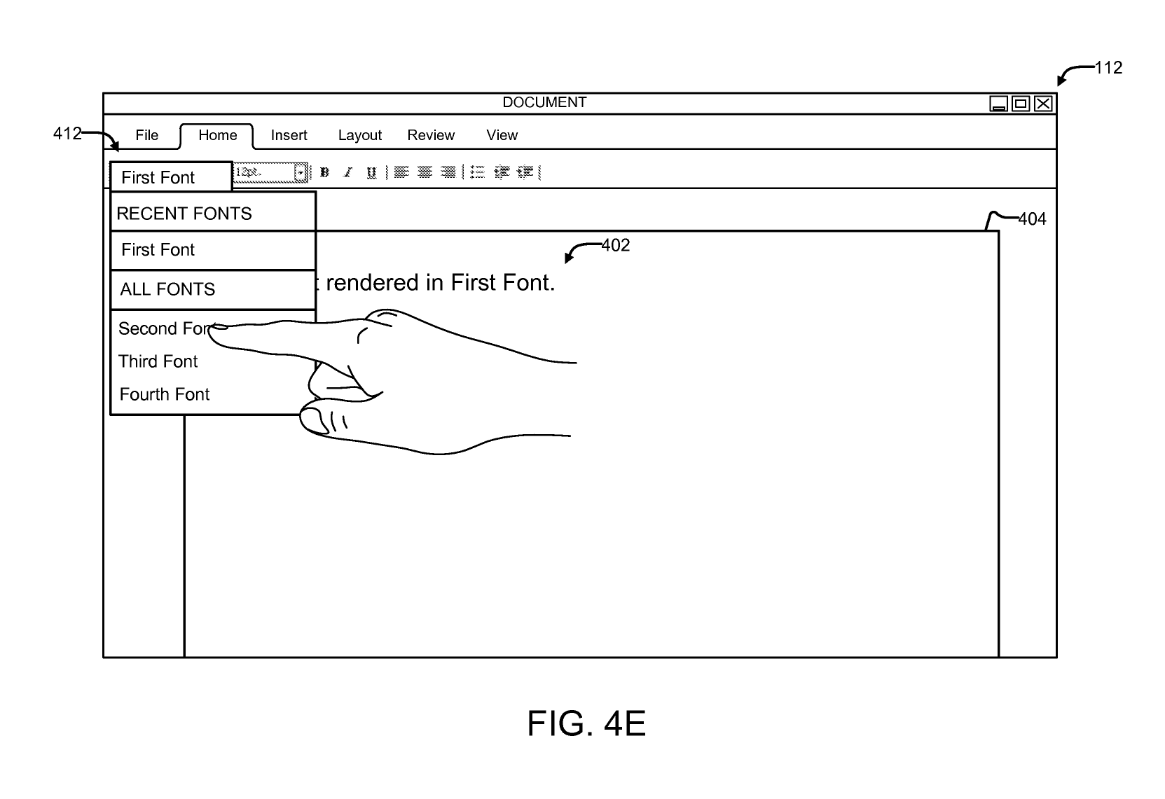

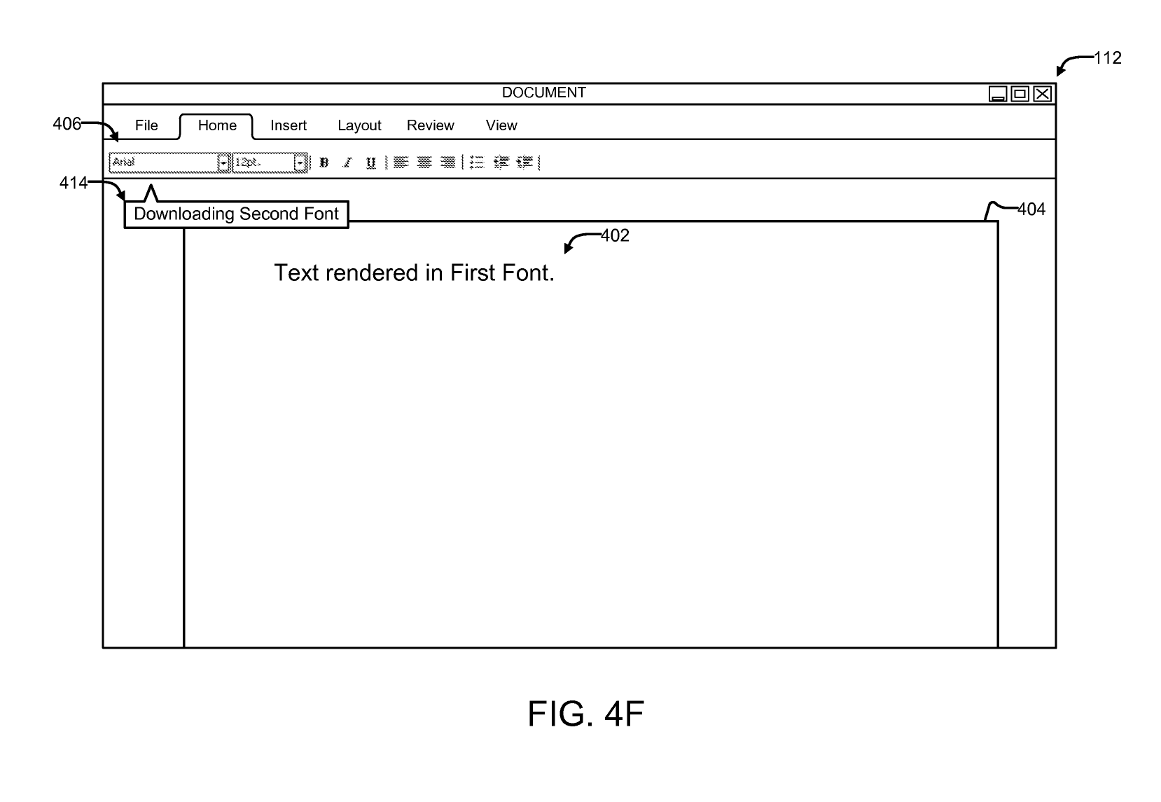

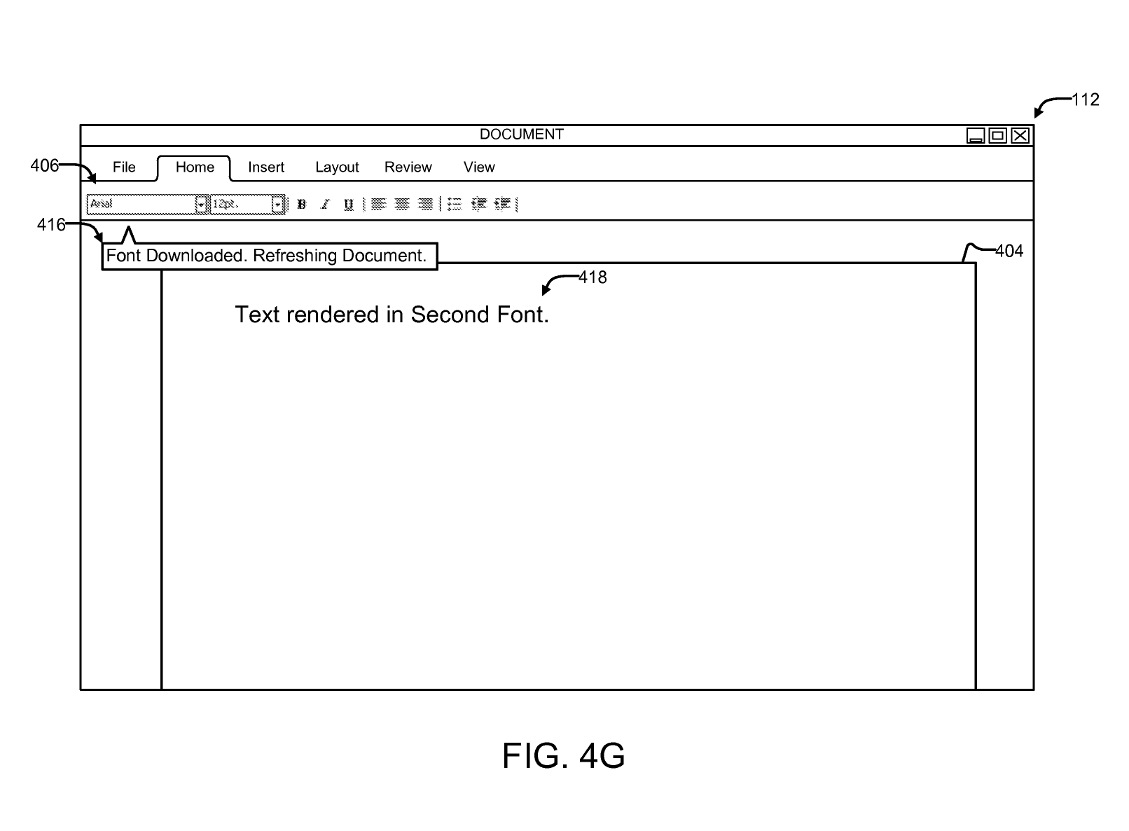

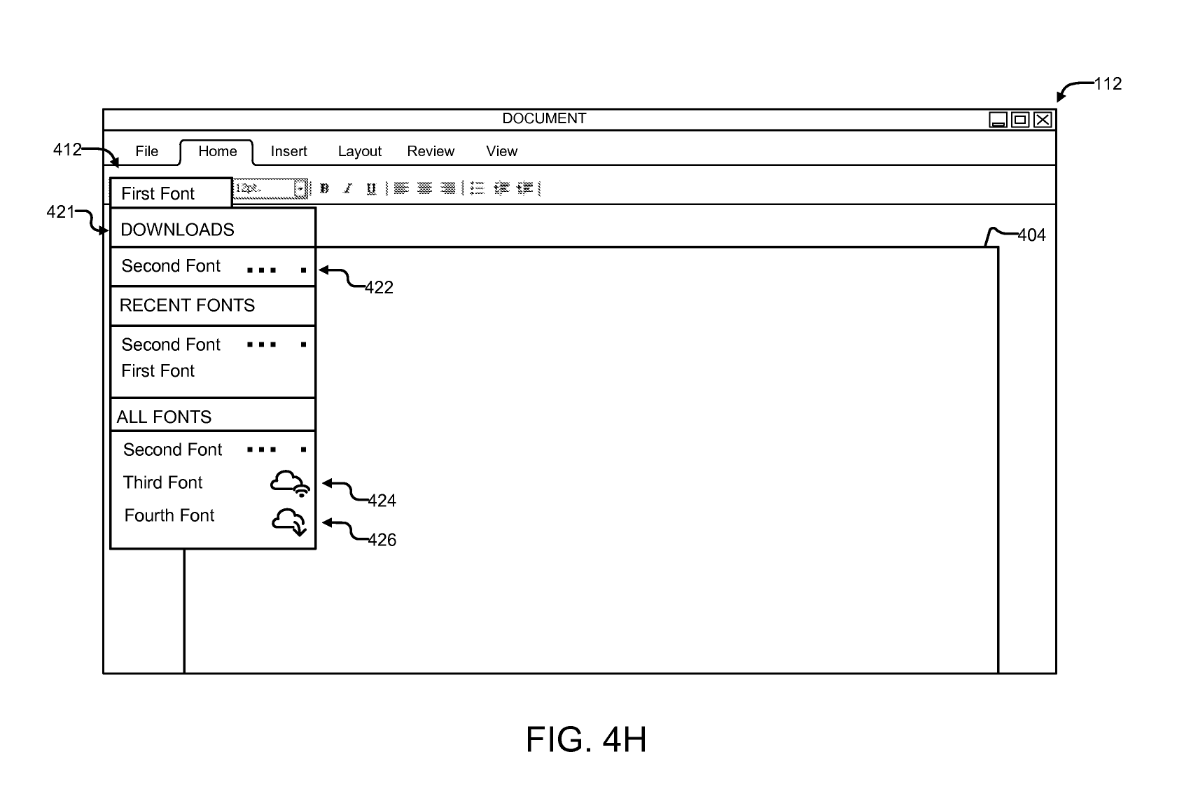

As described above with reference to FIGS. 2-3, user interactions through the user interface 112 and the mobile application 114 enable font requests 108 to be transmitted, and font files 110 to be downloaded, to a client computing device 104. Hereinafter, aspects of the user interface 112 are described more fully with reference to FIGS. 4A-4H.

FIGS. 4A-4H are diagrams of the user interface 112 in various stages of updating fonts, according to one implementation presented herein. As shown in FIG. 4A, the document 118, including text 402 rendered in a first font, is displayed in a viewing port 404. A designation of the first font is displayed in user interface element 406.

Turning to FIG. 4B, a user can select font to be updated by highlighting text 408, using an appropriate gesture or manipulation of the user interface 112. Other forms of font selection may also be applicable. For example, tap-to-select, multi-finger selections, and other gestures may also be applicable. As shown in FIG. 4C, upon selecting text 408, the user can select a font change indication element 410. Upon selecting the font change indication element 410, a font listing 412 of available fonts is displayed as shown in FIG. 4D. Using the font listing 412, the user can select a font, for example, the second font, as shown in FIG. 4E.

Upon selection, the mobile application 114 can initiate an asynchronous download of the second font and can indicate the font is being downloaded with a font download indication element 414 as illustrated in FIG. 4F. Generally, the font download notification element 414 and other notifications can be optional, can be rendered only if a download is estimated to exceed a threshold timeframe, or may be omitted entirely, depending upon any desired implementation. After successful downloading of the second font, the mobile application 114 can indicate that the font has been successfully downloaded and that the document will be refreshed, through an additional font download indication element 416, as shown in FIG. 4G. As further shown in FIG. 4G, appropriate text 418 of the document 118 has been rendered in the second font.

With regard to the font listing 412, additional graphical elements and user interface elements representative of the state of the asynchronous download, the availability of fonts, and other attributes of the system 100, can be rendered at user interface 112 in a “downloads” interface section 421 of the font listing 412. As illustrated in FIG. 4H, an active download progress animation 422 can be rendered proximate to an identification of the second font (or any other font) whose download is currently in progress. Generally, any suitable animation or notification can be rendered to indicate download progress, including progress bars and other similar animations. According to one example implementation, the suitable animation or notifications as arranged in the interface section 421, and the interface section 421 itself, are rendered only when downloads are in progress or have not completed. Furthermore, according to at least one implementation, the download progress animation 422 is an animation that renders motion constantly during the download of a font 110. This is in comparison to a progress bar that can lack any motion during a last few portions of a download. In this manner, a user may always be able to easily identify that a download is in progress.

As further shown in FIG. 4H, connection settings notifications 424 and 426 can be rendered proximate to the indicators for appropriate fonts. For example, the connection setting notification 424 distinguishes that the third font is not available at the client computing system 104, and also simultaneously that the user settings 122 require the third font to be downloaded only over a wireless Internet connection (e.g. a WIFI connection) rather than a cellular data connection. In contrast, the connection setting notification 424 distinguishes that the fourth font is not available at the client computing system 104, and also that the fourth font is available for download from the host computer 106 and/or computing network 107. Other user interface elements, animations, and notifications can also be rendered at the user interface 112. Example elements can include identification elements showing a break or pause in an active download, progress elements showing a total complete progress of a download after a break or pause in an active download, a download reset or retry selection element allowing for a user to retry downloading a font after a pause or break in another download, and other suitable elements.

It should be appreciated that the logical operations described above with reference to FIGS. 2-4 may be implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

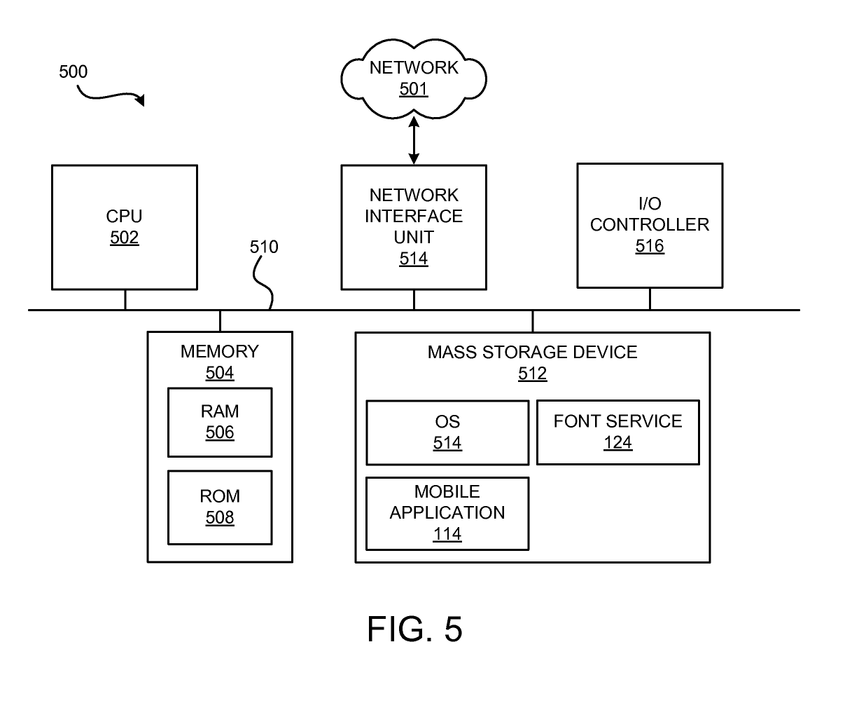

FIG. 5 illustrates an illustrative computer architecture 500 for a device capable of executing the software components described herein for seamless and automatic updating of fonts at a client computing device. Thus, the computer architecture 500 illustrated in FIG. 5 illustrates an architecture for a server computer, mobile phone, a wearable computer, a smart phone, a smart watch, a smart display panel, a desktop computer, a netbook computer, a tablet computer, and/or a laptop computer. The computer architecture 500 can be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing the operating system 514 and one or more application programs including, but not limited to, the mobile application 114 and/or font service 124.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media can include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer architecture 500. For purposes of the claims, the phrase “computer storage medium,” and variations thereof, does not include waves or signals per se and/or communication media.

According to various configurations, the computer architecture 500 can operate in a networked environment using logical connections to remote computers through a network such as the network 104. The computer architecture 500 can connect to the network 104 through a network interface unit 516 connected to the bus 510. It should be appreciated that the network interface unit 516 also can be utilized to connect to other types of networks and remote computer systems. The computer architecture 500 also can include an input/output controller 518 for receiving and processing input from a number of other devices, including a keyboard, mouse, or electronic stylus (not shown in FIG. 5). Similarly, the input/output controller 518 can provide output to a display screen, a printer, or other type of output device (also not shown in FIG. 5).

It should be appreciated that the software components described herein can, when loaded into the CPU 502 and executed, transform the CPU 502 and the overall computer architecture 500 from a general-purpose computing system into a special-purpose computing system customized to facilitate the functionality presented herein. The CPU 502 can be constructed from any number of transistors or other discrete circuit elements, which can individually or collectively assume any number of states. More specifically, the CPU 502 can operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein can be encoded on the computer-readable media by transforming the physical state of the semiconductor memory. For example, the software can transform the state of transistors, capacitors, or other discrete circuit elements constituting the semiconductor memory. The software also can transform the physical state of such components in order to store data thereupon.

As another example, the computer-readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations also can include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 can include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

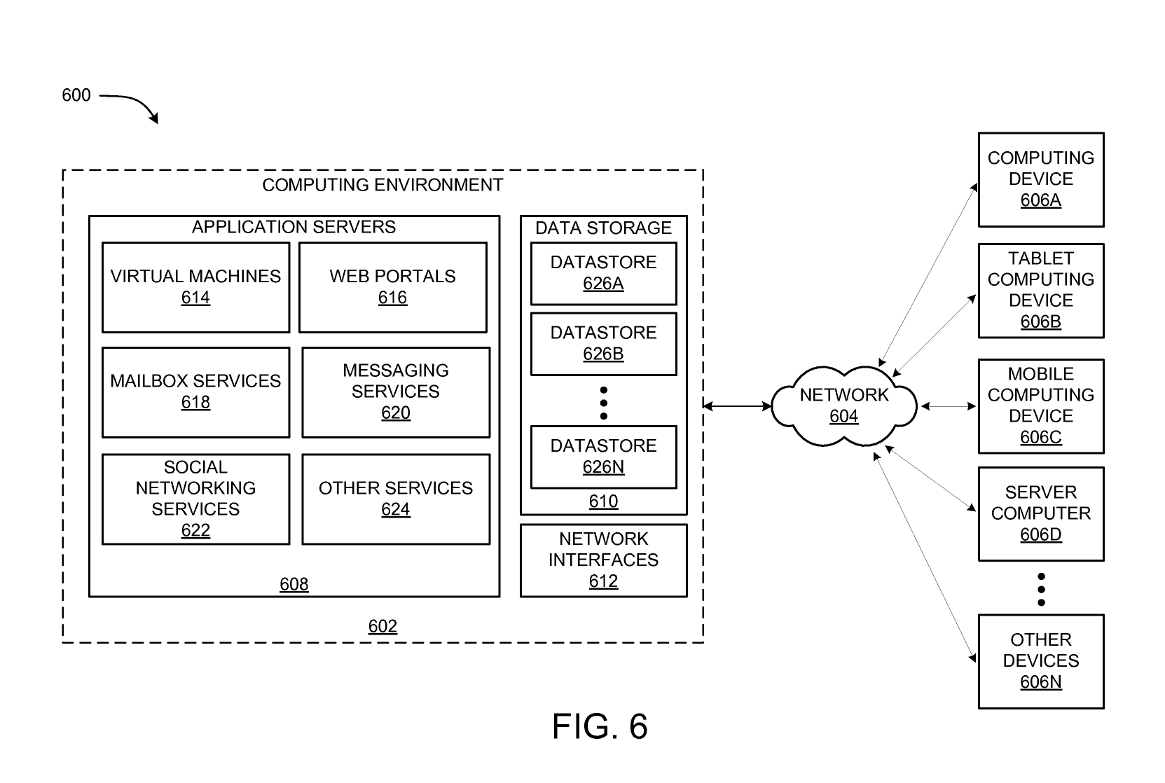

FIG. 6 illustrates an illustrative distributed computing environment 600 capable of executing the software components described herein for seamless and automatic updating of fonts Thus, the distributed computing environment 600 illustrated in FIG. 6 can be used to provide the functionality described herein with respect to the system 100 The distributed computing environment 600 thus may be utilized to execute any aspects of the software components presented herein.

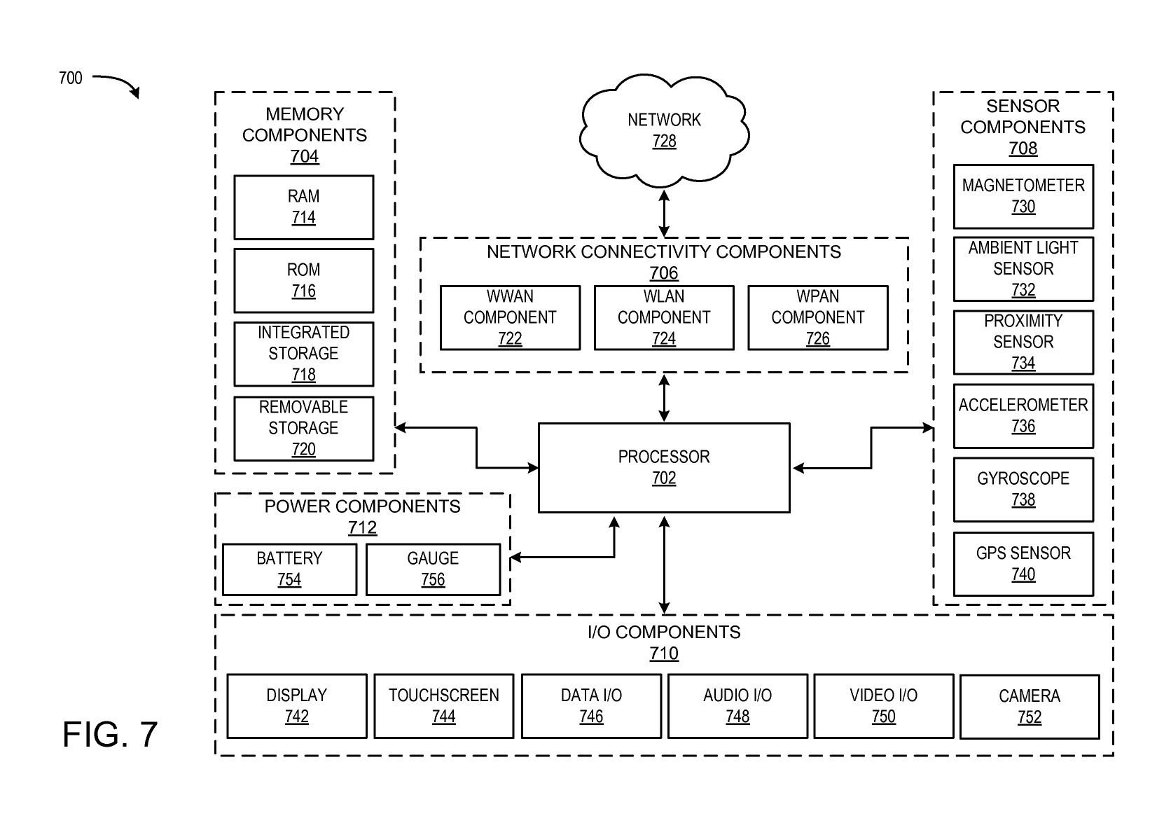

According to various implementations, the distributed computing environment 600 includes a computing environment 602 operating on, in communication with, or as part of the network 604. The network 604 also can include various access networks. One or more client devices 606A-606N (hereinafter referred to collectively and/or generically as “clients 606”) can communicate with the computing environment 602 via the network 604 and/or other connections (not illustrated in FIG. 6). In the illustrated configuration, the clients 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the computing environment 602. Two example computing architectures for the clients 606 are illustrated and described herein with reference to FIGS. 5 and 7. It should be understood that the illustrated clients 606 and computing architectures illustrated and described herein are illustrative, and should not be construed as being limited in any way.

In the illustrated configuration, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated configuration, the application servers 608 host one or more virtual machines 614 for hosting applications or other functionality. According to various implementations, the virtual machines 614 host one or more applications and/or software modules for providing the functionality described herein for the host computer 106 and/or the font service 124. It should be understood that this configuration is illustrative, and should not be construed as being limiting in any way. The application servers 608 also host or provide access to one or more Web portals, link pages, Web sites, and/or other information (“Web portals”) 616.

According to various implementations, the application servers 608 also include one or more mailbox services 618 and one or more messaging services 620. The mailbox services 618 can include electronic mail (“email”) services. The mailbox services 618 also can include various personal information management (“PIM”) services including, but not limited to, calendar services, contact management services, collaboration services, and/or other services. The messaging services 620 can include, but are not limited to, instant messaging services, chat services, forum services, and/or other communication services.

The application servers 608 also can include one or more social networking services 622. The social networking services 622 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 622 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 622 are provided by other services, sites, and/or providers that may or may not explicitly be known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 622 also can include commenting, blogging, and/or microblogging services. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services 622 are not mentioned herein for the sake of brevity. As such, the above configurations are illustrative, and should not be construed as being limited in any way.

As shown in FIG. 6, the application servers 608 also can host other services, applications, portals, and/or other resources (“other resources”) 624. The other resources 624 can include, but are not limited to, the font service 124 and other interrelated resources. It thus can be appreciated that the computing environment 602 can provide integration of the technologies disclosed herein provided herein for collaborative editing of documents with seamless updating of fonts with various mailbox, messaging, social networking, and/or other services or resources. For example, the technologies disclosed herein can allow distribution of a document for sharing amongst a group of users. As one user changes or requests changes to a font in the shared document, the changes to the font can be distributed to the other users automatically such that each version of the shared document is rendered in the appropriate font. The rendering of the shared document on each client computing device of the group of users can be implemented based on an idle status of each user and/or user interface, as described above.

As mentioned above, the computing environment 602 can include the data storage 610. According to various implementations, the functionality of the data storage 610 is provided by one or more databases operating on, or in communication with, the network 604. The functionality of the data storage 610 also can be provided by one or more server computers configured to host data for the computing environment 602. The data storage 610 can include, host, or provide one or more real or virtual datastores 626A-626N (hereinafter referred to collectively and/or generically as “datastores 626”). The datastores 626 are configured to host data used or created by the application servers 608 and/or other data.

The computing environment 602 can communicate with, or be accessed by, the network interfaces 612. The network interfaces 612 can include various types of network hardware and software for supporting communications between two or more computing devices including, but not limited to, the clients 606 and the application servers 608. It should be appreciated that the network interfaces 612 also can be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the technologies disclosed herein, the distributed computing environment 600 provides the software functionality described herein as a service to the clients 606. It should be understood that the clients 606 can include real or virtual machines including, but not limited to, server computers, web servers, personal computers, mobile computing devices, smart phones, and/or other devices. As such, various configurations of the technologies disclosed herein enable any device configured to access the distributed computing environment 600 to utilize the functionality described herein for seamless and automatic updating of fonts.

Turning now to FIG. 7, an illustrative computing device architecture 700 for a computing device that is capable of executing various software components described herein for seamless and automatic updating of fonts. The computing device architecture 700 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. Moreover, the computing device architecture 700 is applicable to any of the clients 706 shown in FIG. 6, and/or the client computing system 104 illustrated in FIG. 1. Furthermore, aspects of the computing device architecture 700 may be applicable to traditional desktop computers, portable computers (e.g., laptops, notebooks, ultra-portables, and netbooks), server computers, and other computer systems, such as described herein with reference to FIG. 5. For example, the single touch and multi-touch aspects disclosed herein below can be applied to desktop computers that utilize a touchscreen or some other touch-enabled device, such as a touch-enabled track pad or touch-enabled mouse.

The computing device architecture 700 illustrated in FIG. 7 includes a processor 702, memory components 704, network connectivity components 706, sensor components 708, input/output components 710, and power components 712. In the illustrated configuration, the processor 702 is in communication with the memory components 704, the network connectivity components 706, the sensor components 708, the input/output (“I/O”) components 710, and the power components 712. Although no connections are shown between the individuals components illustrated in FIG. 7, the components can interact to carry out device functions. In some configurations, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 can be utilized to execute aspects of the software components presented herein and, particularly, those that utilize, at least in part, a touch-enabled input.

In some configurations, the processor 702 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, and greater), video games, three-dimensional (“D”) modeling applications, and the like. In some configurations, the processor 702 is configured to communicate with a discrete GPU (not shown). In any case, the CPU and GPU can be configured in accordance with a co-processing CPU/GPU computing model, wherein the sequential part of an application executes on the CPU and the computationally-intensive part is accelerated by the GPU.

In some configurations, the processor 702 is, or is included in, a system-on-chip (“SoC”) along with one or more of the other components described herein below. For example, the SoC can include the processor 702, a GPU, one or more of the network connectivity components 706, and one or more of the sensor components 708. In some configurations, the processor 702 is fabricated, in part, utilizing a package-on-package (“PoP”) integrated circuit packaging technique. Moreover, the processor 702 can be a single core or multi-core processor.

The processor 702 can be created in accordance with an ARM architecture, available for license from ARM HOLDINGS of Cambridge, United Kingdom. Alternatively, the processor 702 can be created in accordance with an x86 architecture, such as is available from INTEL CORPORATION of Mountain View, Calif. and others. In some configurations, the processor 702 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some configurations, the RAM 714 or a portion thereof, the ROM 716 or a portion thereof, and/or some combination the RAM 714 and the ROM 716 is integrated in the processor 702. In some configurations, the ROM 716 is configured to store a firmware, an operating system or a portion thereof (e.g., operating system kernel), and/or a bootloader to load an operating system kernel from the integrated storage 718 or the removable storage 720.

The integrated storage 718 can include a solid-state memory, a hard disk, or a combination of solid-state memory and a hard disk. The integrated storage 718 can be soldered or otherwise connected to a logic board upon which the processor 702 and other components described herein also can be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some configurations, the removable storage 720 is provided in lieu of the integrated storage 718. In other configurations, the removable storage 720 is provided as additional optional storage. In some configurations, the removable storage 720 is logically combined with the integrated storage 718 such that the total available storage is made available and shown to a user as a total combined capacity of the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various configurations, the operating system includes, but is not limited to, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from a network 728, which may be a WWAN, a WLAN, or a WPAN. Although a single network 728 is illustrated, the network connectivity components 706 can facilitate simultaneous communication with multiple networks. For example, the network connectivity components 706 can facilitate simultaneous communications with multiple networks via one or more of a WWAN, a WLAN, or a WPAN.

The network 728 can be a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 728 can utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications can be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 728 can be configured to provide voice and/or data communications with any combination of the above technologies. The network 728 can be configured to or adapted to provide voice and/or data communications in accordance with future generation technologies.

In some configurations, the WWAN component 722 is configured to provide dual-multi-mode connectivity to the network 728. For example, the WWAN component 722 can be configured to provide connectivity to the network 728, wherein the network 728 provides service via GSM and UMTS technologies, or via some other combination of technologies. Alternatively, multiple WWAN components 722 can be utilized to perform such functionality, and/or provide additional functionality to support other non-compatible technologies (i.e., incapable of being supported by a single WWAN component). The WWAN component 722 may facilitate similar connectivity to multiple networks (e.g., a UMTS network and an LTE network).

The network 728 can be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 724 is configured to connect to the network 728 via the WI-FI access points. Such connections can be secured via various encryption technologies including, but not limited, WI-FI Protected Access (“WPA”), WPA2, Wired Equivalent Privacy (“WEP”), and the like.

The network 728 can be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 726 is configured to facilitate communications with other devices, such as peripherals, computers, or other computing devices via the WPAN.

The sensor components 708 include a magnetometer 730, an ambient light sensor 732, a proximity sensor 734, an accelerometer 736, a gyroscope 738, and a Global Positioning System sensor (“GPS sensor”) 740. It is contemplated that other sensors, such as, but not limited to, temperature sensors or shock detection sensors, also may be incorporated in the computing device architecture 700.

The magnetometer 730 is configured to measure the strength and direction of a magnetic field. In some configurations the magnetometer 730 provides measurements to a compass application program stored within one of the memory components 704 in order to provide a user with accurate directions in a frame of reference including the cardinal directions, north, south, east, and west. Similar measurements can be provided to a navigation application program that includes a compass component. Other uses of measurements obtained by the magnetometer 730 are contemplated.

The ambient light sensor 732 is configured to measure ambient light. In some configurations, the ambient light sensor 732 provides measurements to an application program stored within one the memory components 704 in order to automatically adjust the brightness of a display (described below) to compensate for low-light and high-light environments. Other uses of measurements obtained by the ambient light sensor 732 are contemplated.

The proximity sensor 734 is configured to detect the presence of an object or thing in proximity to the computing device without direct contact. In some configurations, the proximity sensor 734 detects the presence of a user's body (e.g., the user's face) and provides this information to an application program stored within one of the memory components 704 that utilizes the proximity information to enable or disable some functionality of the computing device. For example, a telephone application program can automatically disable a touchscreen (described below) in response to receiving the proximity information so that the user's face does not inadvertently end a call or enable/disable other functionality within the telephone application program during the call. Other uses of proximity as detected by the proximity sensor 734 are contemplated.

The accelerometer 736 is configured to measure proper acceleration. In some configurations, output from the accelerometer 736 is used by an application program as an input mechanism to control some functionality of the application program. For example, the application program can be a video game in which a character, a portion thereof, or an object is moved or otherwise manipulated in response to input received via the accelerometer 736. In some configurations, output from the accelerometer 736 is provided to an application program for use in switching between landscape and portrait modes, calculating coordinate acceleration, or detecting a fall. Other uses of the accelerometer 736 are contemplated.

The gyroscope 738 is configured to measure and maintain orientation. In some configurations, output from the gyroscope 738 is used by an application program as an input mechanism to control some functionality of the application program. For example, the gyroscope 738 can be used for accurate recognition of movement within a 3D environment of a video game application or some other application. In some configurations, an application program utilizes output from the gyroscope 738 and the accelerometer 736 to enhance control of some functionality of the application program. Other uses of the gyroscope 738 are contemplated.

The GPS sensor 740 is configured to receive signals from GPS satellites for use in calculating a location. The location calculated by the GPS sensor 740 can be used by any application program that requires or benefits from location information. For example, the location calculated by the GPS sensor 740 can be used with a navigation application program to provide directions from the location to a destination or directions from the destination to the location. Moreover, the GPS sensor 740 can be used to provide location information to an external location-based service, such as E911 service. The GPS sensor 740 can obtain location information generated via WI-FI, WIMAX, and/or cellular triangulation techniques utilizing one or more of the network connectivity components 706 to aid the GPS sensor 740 in obtaining a location fix. The GPS sensor 740 can also be used in Assisted GPS (“A-GPS”) systems.

The I/O components 710 include a display 742, a touchscreen 744, a data I/O interface component (“data I/O”) 746, an audio I/O interface component (“audio I/O”) 748, a video I/O interface component (“video I/O”) 750, and a camera 752. In some configurations, the display 742 and the touchscreen 744 are combined. In some configurations two or more of the data I/O component 746, the audio I/O component 748, and the video I/O component 750 are combined. The I/O components 710 can include discrete processors configured to support the various interface described below, or can include processing functionality built-in to the processor 702.

The display 742 is an output device configured to present information in a visual form. In particular, the display 742 can present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 742 is a liquid crystal display (“LCD”) utilizing any active or passive matrix technology and any backlighting technology (if used). In some configurations, the display 742 is an organic light emitting diode (“OLED”) display. Other display types are contemplated.

The touchscreen 744 is an input device configured to detect the presence and location of a touch. The touchscreen 744 can be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or can utilize any other touchscreen technology. In some configurations, the touchscreen 744 is incorporated on top of the display 742 as a transparent layer to enable a user to use one or more touches to interact with objects or other information presented on the display 742. In other configurations, the touchscreen 744 is a touch pad incorporated on a surface of the computing device that does not include the display 742. For example, the computing device can have a touchscreen incorporated on top of the display 742 and a touch pad on a surface opposite the display 742.

In some configurations, the touchscreen 744 is a single-touch touchscreen. In other configurations, the touchscreen 744 is a multi-touch touchscreen. In some configurations, the touchscreen 744 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures can be implemented in software for use with the touchscreen 744. As such, a developer can create gestures that are specific to a particular application program.

In some configurations, the touchscreen 744 supports a tap gesture in which a user taps the touchscreen 744 once on an item presented on the display 742. The tap gesture can be used for various reasons including, but not limited to, opening or launching whatever the user taps. In some configurations, the touchscreen 744 supports a double tap gesture in which a user taps the touchscreen 744 twice on an item presented on the display 742. The double tap gesture can be used for various reasons including, but not limited to, zooming in or zooming out in stages. In some configurations, the touchscreen 744 supports a tap and hold gesture in which a user taps the touchscreen 744 and maintains contact for at least a pre-defined time. The tap and hold gesture can be used for various reasons including, but not limited to, opening a context-specific menu.

In some configurations, the touchscreen 744 supports a pan gesture in which a user places a finger on the touchscreen 744 and maintains contact with the touchscreen 744 while moving the finger on the touchscreen 744. The pan gesture can be used for various reasons including, but not limited to, moving through screens, images, or menus at a controlled rate. Multiple finger pan gestures are also contemplated. In some configurations, the touchscreen 744 supports a flick gesture in which a user swipes a finger in the direction the user wants the screen to move. The flick gesture can be used for various reasons including, but not limited to, scrolling horizontally or vertically through menus or pages. In some configurations, the touchscreen 744 supports a pinch and stretch gesture in which a user makes a pinching motion with two fingers (e.g., thumb and forefinger) on the touchscreen 744 or moves the two fingers apart. The pinch and stretch gesture can be used for various reasons including, but not limited to, zooming gradually in or out of a website, map, or picture.

Although the above gestures have been described with reference to the use one or more fingers for performing the gestures, other appendages such as toes or objects such as styluses can be used to interact with the touchscreen 744. As such, the above gestures should be understood as being illustrative and should not be construed as being limiting in any way.

FIGS. 4A-4H illustrate various states of the user interface 112 and various gestures and user input that can be used to trigger the technologies described herein. For example, selection of text and subsequent requests for updated or new font files can be implemented through gestures as described above. Furthermore, various notifications, animations, and other user interface elements can be implemented to provide information to a user with regard to a status of font updates.

The data I/O interface component 746 is configured to facilitate input of data to the computing device and output of data from the computing device. In some configurations, the data I/O interface component 746 includes a connector configured to provide wired connectivity between the computing device and a computer system, for example, for synchronization operation purposes. The connector can be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 748 is configured to provide audio input and/or output capabilities to the computing device. In some configurations, the audio I/O interface component 746 includes a microphone configured to collect audio signals. In some configurations, the audio I/O interface component 746 includes a headphone jack configured to provide connectivity for headphones or other external speakers. In some configurations, the audio interface component 748 includes a speaker for the output of audio signals. In some configurations, the audio I/O interface component 746 includes an optical audio cable out.

The video I/O interface component 750 is configured to provide video input and/or output capabilities to the computing device. In some configurations, the video I/O interface component 750 includes a video connector configured to receive video as input from another device (e.g., a video media player such as a DVD or BLURAY player) or send video as output to another device (e.g., a monitor, a television, or some other external display). In some configurations, the video I/O interface component 750 includes a High-Definition Multimedia Interface (“HDMI”), mini-HDMI, micro-HDMI, DisplayPort, or proprietary connector to input/output video content. In some configurations, the video I/O interface component 750 or portions thereof is combined with the audio I/O interface component 748 or portions thereof.

The camera 752 can be configured to capture still images and/or video. The camera 752 can utilize a charge coupled device (“CCD”) or a complementary metal oxide semiconductor (“CMOS”) image sensor to capture images. In some configurations, the camera 752 includes a flash to aid in taking pictures in low-light environments. Settings for the camera 752 can be implemented as hardware or software buttons.

Although not illustrated, one or more hardware buttons can also be included in the computing device architecture 700. The hardware buttons can be used for controlling some operational aspect of the computing device. The hardware buttons can be dedicated buttons or multi-use buttons. The hardware buttons can be mechanical or sensor-based.

The illustrated power components 712 include one or more batteries 754, which can be connected to a battery gauge 756. The batteries 754 can be rechargeable or disposable. Rechargeable battery types include, but are not limited to, lithium polymer, lithium ion, nickel cadmium, and nickel metal hydride. Each of the batteries 754 can be made of one or more cells.

The battery gauge 756 can be configured to measure battery parameters such as current, voltage, and temperature. In some configurations, the battery gauge 756 is configured to measure the effect of a battery's discharge rate, temperature, age and other factors to predict remaining life within a certain percentage of error. In some configurations, the battery gauge 756 provides measurements to an application program that is configured to utilize the measurements to present useful power management data to a user. Power management data can include one or more of a percentage of battery used, a percentage of battery remaining, a battery condition, a remaining time, a remaining capacity (e.g., in watt hours), a current draw, and a voltage.

The power components 712 can also include a power connector, which can be combined with one or more of the aforementioned I/O components 710. The power components 712 can interface with an external power system or charging equipment via a power I/O component 744.

The disclosure presented herein encompasses the subject matter set forth in the following clauses:

A. A device comprising a processor and a memory, the memory storing an application configured to: receive a selection of a portion of text in a document, the portion of the text being rendered in a first font within a viewing port of a user interface provided by the application; receive a request to update or change the first font for the selected portion of the text; display a font listing of available fonts in response to the received request; receive a selection of a second font from the font listing, the second font being a font available from a font service in operative communication with the device; initiate an asynchronous download of the second font from the font service; and in response to the asynchronous download of the second font being complete and successful, refresh or re-render of the selected portion of the text in the second font.

B. A device as recited in clause A, wherein the selection of the portion of the text comprises a selection of text through the user interface.

C. A device as recited in either of clauses A and B, wherein the request to update or change the first font comprises selection of a font change indication element of the user interface.

D. A device as recited in any of clauses A-C, wherein displaying the font listing comprises rendering a listing of the available fonts on the user interface.

E. A device as recited in any of clauses A-D, wherein the font listing comprises: a list of fonts stored at the device; and a list of fonts available to download to the device.

F. A device as recited in any of clauses A-E, wherein the list of fonts available to download to the device comprises at least an indication of the second font and a user interface element indicating the second font is available to download.

F. A device as recited in any of clauses A-F, wherein the list of fonts available to download to the device comprises at least an indication of the second font and a user interface element indicating the second font is available to download while the device has a wireless Internet connection.

G. A device as recited in any of clauses A-G, wherein receiving the selection of the second font comprises receiving a selection from the font listing rendered through the user interface.

H. A device as recited in any of clauses A-G, wherein initiating the asynchronous download of the second font comprises: indicating that the second font is being downloaded; determining a temporary font related to the second font that is available at the device; and rendering the selected text in the temporary font.

I. A device as recited in any of clauses A-H, wherein refreshing or re-rendering of the selected portion of the text in the second font comprises: determining that the user interface is idle; and in response to the user interface being idle, re-rendering the selected text in the second font.

J. A device as recited in any of clauses A-I, wherein re-rendering the selected text in the second font comprises rendering a portion of the selected text being actively viewed in the viewing port of the user interface, and subsequent to rendering the portion of the selected text being actively viewed, rendering remaining portions of the selected text.

K. A system, comprising: a host computer having a font service deployed thereon and configured to serve font files to client computing devices; and a client computing device having an application deployed thereon and configured to: receive a request to update or change a first font associated with text in a document from a user interface generated by the application; display a font listing of available fonts in response to the received request; receive a selection of a second font from the font listing, the second font being a font available from the font service; initiate an asynchronous download of the second font from the font service; and in response to the asynchronous download of the second font being complete and successful, automatically refresh or re-render the text in the second font.

L. A system as recited in clause K, wherein the request to update or change the first font comprises selection of a font change indication element of the user interface.

M. A system as recited in either of clauses K and L, wherein displaying the font listing comprises rendering a listing of the available fonts on the user interface.

N. A system as recited in any of clauses K-M, wherein the font listing comprises: a list of fonts stored at the client computing device; and a list of fonts served by the font service.

O. A system as recited in any of clauses K-N, wherein the list of fonts served by the font service comprises an indication of at least the second font and a user interface element indicating the second font is available to download.

P. A system as recited in any of clauses K-O, wherein the list of fonts served by the font service comprises an indication of at least the second font and a user interface element indicating the second font is available to download while the client computing device is in operative communication with the host computer.

Q. A system as recited in any of clauses K-P, wherein receiving the selection of the second font comprises receiving a selection from the font listing rendered through the user interface.

R. A system as recited in any of clauses K-Q, wherein initiating the asynchronous download of the second font comprises: indicating that the second font is being downloaded; identifying a temporary font related to the second font that is available at the device, the temporary font being determined through a PANOSE algorithm; and rendering the selected text in the temporary font.

S. A system for seamless and automatic updating of fonts across client computing devices, the system comprising: a host computer having a font service executing thereupon, the font service configured to serve font files to client computing devices; a font data store in operative communication with the font service and configured to store the font files; and a client computing device in operative communication with the font service, the client computing device having an application deployed thereon and configured to: receive a selection of a portion of text in a document, the portion of the text being rendered in a first font in a view port of a user interface provided by the application; receive a request to update or change the first font for the selected portion of the text; display a font listing of available fonts in response to the received request, the font listing comprising at least a second font and a user interface element indicating that the second font is available to download from the font service; receive a selection of the second font from the font listing; initiate an asynchronous download of the second font from the font service; display an indication that the second font is being downloaded; determine a temporary font related to the second font that is available at the client computing device in response to initiating the asynchronous download; render the selected text in the temporary font; determine that the asynchronous download of the second font is complete and successful; in response to determining that the asynchronous download of the second font is complete and successful, determine that a user interface in communication with the mobile application is idle; and in response to determining that the user interface is idle, refresh or re-render the selected text in the second font.

Although the subject matter has been described in language specific to structural features and/or methodological acts, it is to be understood that the subject matter defined in the appended claims is not necessarily limited to the specific features or acts described. Rather, the specific features and steps are disclosed as example forms of implementing the claims.

All of the methods and processes described above may be embodied in, and fully or partially automated via, software code modules executed by one or more general purpose computers or processors. The code modules may be stored in any type of computer-readable storage medium or other computer storage device. Some or all of the methods may additionally or alternatively be embodied in specialized computer hardware.

Conditional language such as, among others, “can,” “could,” or “may,” unless specifically stated otherwise, means that certain examples include, while other examples do not include, certain features, elements and/or steps. Thus, such conditional language does not imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrases “and/or” and “at least one of X, Y or Z,” unless specifically stated otherwise, mean that an item, term, etc. may be either X, Y, or Z, or a combination thereof. Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A device (104) comprising a processor and a memory (111), the memory (111) storing an application (114) configured to:
receive (202) a selection of a portion of text in a document (118), the portion of the text being rendered in a first font within a viewing port (404) of a user interface (112) provided by the application (114);
receive (204) a request to update or change the first font for the selected portion of the text;
display (206) a font listing of available fonts in response to the received request;
receive (208) a selection of a second font from the font listing (412), the second font being a font available from a font service (124) in operative communication with the device (104);
initiate (210) an asynchronous download of the second font from the font service (124); and
in response to the asynchronous download of the second font being complete and successful, refresh (214) or re-render of the selected portion of the text in the second font.

2. The device of claim 1, wherein the selection of the portion of the text comprises a selection of text through the user interface.

3. The device of claim 1, wherein the request to update or change the first font comprises selection of a font change indication element of the user interface.

4. The device of claim 1, wherein displaying the font listing comprises rendering a listing of the available fonts on the user interface.

5. The device of claim 1, wherein the font listing comprises:
a list of fonts stored at the device; and
a list of fonts available to download to the device.

6. The device of claim 5, wherein the list of fonts available to download to the device comprises at least an indication of the second font and a user interface element indicating the second font is available to download.

7. The device of claim 5, wherein the list of fonts available to download to the device comprises at least an indication of the second font and a user interface element indicating the second font is available to download while the device has a wireless Internet connection.

8. The device of claim 1, wherein receiving the selection of the second font comprises receiving a selection from the font listing rendered through the user interface.

9. The device of claim 1, wherein initiating the asynchronous download of the second font comprises:
indicating that the second font is being downloaded;
determining a temporary font related to the second font that is available at the device; and
rendering the selected text in the temporary font.

10. The device of claim 1, wherein refreshing or re-rendering of the selected portion of the text in the second font comprises:
determining that the user interface is idle; and
in response to the user interface being idle, re-rendering the selected text in the second font.

11. The device of claim 10, wherein re-rendering the selected text in the second font comprises rendering a portion of the selected text being actively viewed in the viewing port of the user interface, and subsequent to rendering the portion of the selected text being actively viewed, rendering remaining portions of the selected text.

12. A system (100), comprising:
a host computer (106) having a font service (124) deployed thereon and configured to serve font files (110) to client computing devices; and
a client computing device (104) having an application (114) deployed thereon and configured to:
receive (204) a request to update or change a first font associated with text in a document from a user interface (112) generated by the application (114);
display (206) a font listing (412) of available fonts in response to the received request;
receive (208) a selection of a second font from the font listing (412), the second font being a font available from the font service (124);
initiate (210) an asynchronous download of the second font from the font service (124); and
in response to the asynchronous download of the second font being complete and successful, automatically refresh (214) or re-render the text in the second font.

13. The system of claim 12, wherein the request to update or change the first font comprises selection of a font change indication element of the user interface.

14. The system of claim 12, wherein displaying the font listing comprises rendering a listing of the available fonts on the user interface.

15. The system of claim 12, wherein the font listing comprises:
a list of fonts stored at the client computing device; and
a list of fonts served by the font service.

16. The system of claim 15, wherein the list of fonts served by the font service comprises an indication of at least the second font and a user interface element indicating the second font is available to download.

17. The system of claim 15, wherein the list of fonts served by the font service comprises an indication of at least the second font and a user interface element indicating the second font is available to download while the client computing device is in operative communication with the host computer.

18. The system of claim 12, wherein receiving the selection of the second font comprises receiving a selection from the font listing rendered through the user interface.

19. The system of claim 12, wherein initiating the asynchronous download of the second font comprises:
indicating that the second font is being downloaded;
identifying a temporary font related to the second font that is available at the device, the temporary font being determined through a PANOSE algorithm; and
rendering the selected text in the temporary font.

20. A system (100) for seamless and automatic updating of fonts across client computing devices, the system comprising:
a host computer (106) having a font service (124) executing thereupon, the font service (124) configured to serve font files (110) to client computing devices;
a font data store (128) in operative communication with the font service (124) and configured to store the font files (110); and
a client computing device (104) in operative communication with the font service (124), the client computing device (104) having an application (114) deployed thereon and configured to:
receive (202) a selection of a portion of text in a document (118), the portion of the text being rendered in a first font in a view port of a user interface (112) provided by the application (114);
receive (204) a request to update or change the first font for the selected portion of the text;
display (206) a font listing (412) of available fonts in response to the received request, the font listing (412) comprising at least a second font and a user interface element (426) indicating that the second font is available to download from the font service (124);
receive a (208) selection of the second font from the font listing;
initiate (210) an asynchronous download of the second font from the font service;
display (302) an indication that the second font is being downloaded;
determine (304) a temporary font related to the second font that is available at the client computing device (104) in response to initiating the asynchronous download;
render (306) the selected text in the temporary font;
determine (308) that the asynchronous download of the second font is complete and successful;
in response to determining that the asynchronous download of the second font is complete and successful, determine (212) that a user interface in communication with the mobile application is idle; and
in response to determining that the user interface is idle, refresh (214) or re-render the selected text in the second font.
